(19) United States
(12) Patent Application Publication
(10) Pub. No.: US 2018/0192030 A1
(43) Pub. Date: Jul. 5, 2018

(54) 4-D Video Of An Object Using A Microscope

(71) Applicant: Gary Greenberg, Paia, HI (US)

(72) Inventor: Gary Greenberg, Paia, HI (US)

(21) Appl. No.: 15/616,550

(22) Filed: Jun. 7, 2017

Related U.S. Application Data
(60) Provisional application No. 62/346,685, filed on Jun. 7, 2016.

(51) Int. Cl. H04N 13/02; H04N 13/04; G02B 21/22; G02B 21/36

(52) U.S. Cl. CPC H04N 13/0225; H04N 13/04; H04N 13/0253; G02B 21/367; G02B 21/22

(57) ABSTRACT

Methods and apparatus using a light microscope to simultaneously produce both a stereo 3-D and a motion parallax 3-D video of an object.

### SUMMARY

Methods and apparatus are disclosed for producing a 4-D video of a static object (specimen) by simultaneously producing both stereo 3-D and motion parallax 3-D videos using a light microscope with a single objective lens and a single camera. A unique sequence of “non-conventional” stereo-pair images can be displayed as a video so that the specimen appears to rotate or tilt in stereo 3-D. This gives a static 3-D object the extra dimension of time, creating “4-D” movie loops that enhance the informational value of the object being observed. Both hardware apparatus and software program embodiments are disclosed. The hardware apparatus embodiment produces “4-D” information in near real-time (video rate).

As used herein, “parallax angle” is a displacement or difference in the apparent position of an object viewed along two different lines of sight and is measured by the angle or semi-angle of inclination between those two lines of sight.

A “conventional” stereo-pair image is designed to mimic the stereo imaging properties of the human eye-brain complex, which produces two 2-D images from slightly different parallax angles, known as the left-eye view and the right-eye view. The brain automatically processes these 2-D images into a 3-D image that provides the perception of depth information. A conventional stereo-pair image consists of two images whose parallax angle is congruent with the horizontal x-axis, because human eyes are disposed along the x-axis. In addition, the “conventional” left-eye view and the right-eye view are equally disposed at the same angle on either side of the line of sight.

As used herein the term, “Non-conventional” stereo-pair images of an object are defined as left-eye and right-eye stereo-pair images with one or more of the following characteristics:

1. Left-eye/right-eye stereo-pair images whose parallax angles are not symmetrical about the optical axis;

2. Left-eye/right-eye stereo-pair images whose parallax angle is not directly opposite to one another;

3. Left-eye/right-eye stereo-pair images whose parallax angles are not aligned with the X-axis plane of the object (specimen).

The methods and devices of the invention work in two basic ways: (1) a computer synchronizes a pair of light beams that produce left and right eye views of an object which produce a sequence of stereo-pair images captured by a camera, which images are delivered as stereo-pair images to a 3-D display device producing a 3-D stereo video of the object that appears to rock, roll and/or rotate; and 2) a method and device that first creates a three-dimensional data set of images taken at successive focus levels (“Z-stacked” image set), and then creates a series of unique, non-conventional 3-D stereo-pair images and synchronizes them with a 3-D display system to produce “4-D” videos (3-D stereo video with motional parallax of a static object).

### BACKGROUND

It is well known in the prior art that a stereo 3-D image can be produced by displaying a left-angled view to the left eye of the observer and a right-angled view to the right eye (see Greenberg U.S. Pat. Nos. 6,646,819 B2; 6,798,570; 6,891,671).

Conventional (prior art) 3-D stereo images are created by a left-eye view that is 180 degrees opposed to the right-eye view, and both the left and right views are in alignment with the horizontal x-axis of the specimen. In addition, the parallax angles of the left-eye and right-eye views are radially symmetrical relative to the optical axis (z-axis).

Referring to FIGS. 1A and 2A, according to the prior art, stereo pair images of a specimen 10 can be created in a light microscope 11 and captured in a camera 12. Microscope 11 comprising an illumination source 13, a condenser lens 14 having an aperture 16, an aperture stop (mask) 17 that occludes a portion of the aperture 16 and an objective lens 18.

A left eye view image of specimen 10 is created by positioning aperture stop 17 to occlude a portion of the aperture 16 causing the specimen 10 to be illuminated by a light beam 22 that passes through the unoccluded portion of the condenser lens 14 and emerges at an angle 23 relative to the optical axis 24 of the microscope 11. Beam 22 passes through objective lens 18 and emerges as beam 25 at an angle 26 relative to optical axis 21 on its way to the camera 12.

Referring to FIGS. 1B and 2B, according to the prior art, a right eye view of specimen 10 is created by positioning aperture stop 17 to occlude an opposite portion of the aperture 16 causing the specimen 10 to be illuminated by a light beam 27 that passes through the unoccluded portion of the condenser lens 14 and emerges at an angle 28 relative to the optical axis 24 of the microscope 11. Beam 27 passes through objective lens 18 and emerges as beam 28 at an angle 29 relative to optical axis 21 on its way to the camera 12.

It is known in the prior art that illuminating a microscope specimen from a single point of view that continually changes angle produces motion parallax 3-D. FIG. 3 shows an oblique illumination system that creates a series of successive illumination angles that produces a rotational movie loop, enabling 3-D depth perception using a 2-D display system.

Referring to FIG. 3, it is known in the prior art that an aperture mask 33, such as mask (stop) 17 referred to above, having a light transmitting portion 34 and a light blocking portion 36 can be operatively attached to a motor 37 by a belt 29 or the like by which the orientation of the mask 33 can be selected and/or the mask can be rotated to continually change the illumination angle.

In the prior art, as shown in FIG. 2, 3-D stereo images can be perceived by the human brain in a light microscope by illuminating the specimen at a 0-degree angle with the left eye (relative to the x-axis of the specimen plane), and a 180-degree angle with the right eye (relative to the x-axis of the specimen plane). The left and right illumination paths are 180 degrees opposed to one another in a horizontal orientation relative to the plane of the specimen because human eyes are physically disposed 180 degrees apart and oriented to the horizontal x-axis.

### Novel Methods and Apparatus

Three-dimensional microscope images can be seen as either stereo-pair 3-D images or as motion parallax 3-D videos (rotational movie loops), but not both at the same time. In this patent, unique methods and devices are disclosed for producing simultaneous perception of stereo 3-D and motion parallax 3-D images from a static, non-moving microscope specimen. Stereo 3-D images in a light microscope only provide 3-D information from left and right points of view. Using this method, stereo 3-D images can be dramatically enhanced by providing depth information that includes left and right, up and down, and rotational points of view. This provides more accurate information about the three-dimensional structures being examined. This patent discloses both nearly real-time (video rate) as well as computational methods for achieving this type of enhanced “4-D” imaging mode.

Conventional stereo-pair images are created by producing left-eye and right-eye angled images of an object whereby the left and right angles 1) are radially symmetrical about the optical access, and 2) the left and right images are oriented in line with the horizontal axis, as diagramed in FIG. 2. The new method is based on producing a sequence of unique stereo-pair images, whereby the left-eye and right-eye parallax angles are not aligned with the horizontal x-axis of the specimen plane, and/or are not symmetrical to the optical z-axis and/or are not 180 degrees apart from one another.

### DESCRIPTION OF DRAWINGS

FIG. 1A is a schematic side view of a prior art microscope employing oblique illumination to produce a left eye view of a specimen;

FIG. 1B is a schematic side view of a prior art microscope employing oblique illumination to produce a right eye view of a specimen;

FIG. 2A is a top view of a microscope aperture only partially illuminated to create a left eye view;

FIG. 2B is a top view of a microscope aperture only partially illuminated to create a right eye view;

FIG. 3 is an isometric illustration of prior art microscope components including a rotatable illumination aperture mask;

FIG. 4A is a schematic illustration of a pair of microscope illumination aperture masks shown at a first mirror image angular position that produces first stereo pair images of a specimen that appears to tilt vertically downward;

FIG. 4B is a schematic illustration of a pair of microscope illumination aperture masks shown at second mirror image angular positions that produce a second stereo pair images of a specimen with less vertical tilt downward than shown in FIG. 4A;

FIG. 4C is a schematic illustration of a pair of microscope illumination aperture masks shown at third mirror image angular positions that produce third stereo pair images of a specimen with not apparent vertical tilt;

FIG. 4D is a schematic illustration of a pair of microscope illumination aperture masks shown at fourth mirror image angular positions that produce fourth stereo pair images of a specimen that appears to tilt vertically upward;

FIG. 4E is a schematic illustration of a pair of microscope illumination aperture masks shown at fifth mirror image angular positions that produce fifth stereo pair images of a specimen that appears to tilt vertically upward to a greater degree than shown in FIG. 4D;

FIG. 5 is a schematic illustration of an example of an embodiment of a microscope system of the invention;

FIG. 6 is a schematic illustration showing the various angles of oblique illumination created by an aperture mask similar to FIG. 4 that produces a stereo image that appears to roll from left to right;

FIG. 7A is a schematic illustration of side views of Z-Stack images of three small spheres produced by the components of the invention;

FIG. 7B is a schematic illustration of side views of Z-Stack images of a specimen showing how each individual layer in the stack of images can be displaced horizontally to produce a left-eye view of a stereo pair image;

FIG. 7C is a schematic illustration of side views of Z-Stack images of a specimen showing how each individual layer in the stack of images can be displaced horizontally to produce a right-eye view of a stereo pair image;

FIG. 7D is a schematic illustration of top views of a corresponding stereo-pair of Z-Stack images produced by the components of the invention;

FIG. 8A is a schematic illustration of Z-stack image series in which each layer is independently displaced in both the x-plane and the y-plane to produce non-conventional stereo pair image of a specimen that appear to tilt vertically downward;

FIG. 8B is a schematic illustration of Z-stack image series in which each layer is independently displaced in both the x-plane and the y-plane to produce non-conventional stereo pair images of a specimen that appear to tilt vertically downward to a lesser degree than shown in FIG. 8A;

FIG. 8C is a schematic illustration of Z-stack image series in which each layer is independently displaced in only the x-plane to produce conventional stereo-pair images that do not appear to tilt vertically upward or downward;

FIG. 8D is a schematic illustration of Z-stack image series in which each layer is independently displaced in both the x-plane and the y-plane to produce non-conventional stereo pair image of a specimen that appear to tilt vertically upward;

FIG. 8E is a schematic illustration of Z-stack image series in which each layer is independently displaced in both the x-plane and the y-plane to produce non-conventional stereo pair image of a specimen that appear to tilt vertically upward to a greater degree than shown in FIG. 8D;

FIG. 9A is a schematic illustration of Z-stack image series in which each layer is independently displaced in the x-plane to produce a non-conventional stereo pair image with a more extreme right-eye view;

FIG. 9B is a schematic illustration of Z-stack image series in which each layer is independently displaced in the x-plane to produce a conventional stereo pair image;

FIG. 9C is a schematic illustration of Z-stack image series in which each layer is independently displaced in the x-plane to produce a non-conventional stereo pair image with a more extreme left-eye view. When the images produced by FIGS. 9A-C are displayed sequentially, it produces a 4D movie loop of the specimen appearing to roll left and right.

### DETAILED DESCRIPTION OF SAMPLE EMBODIMENTS OF THE INVENTION

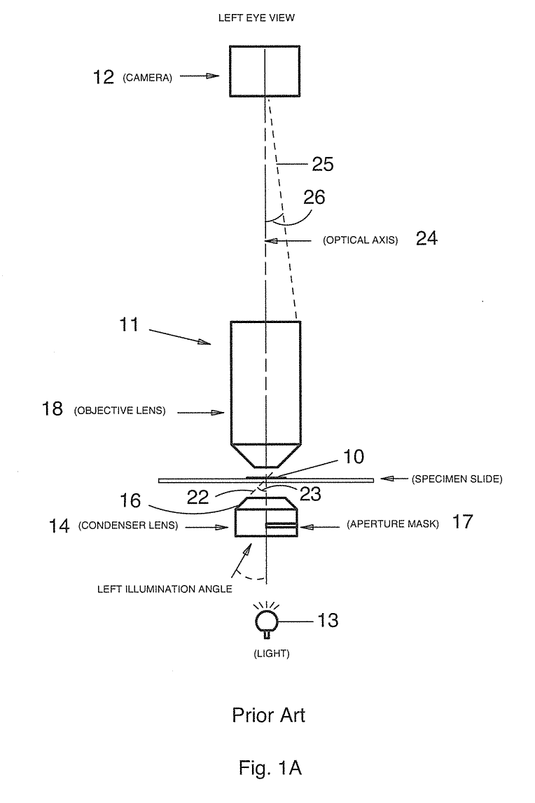

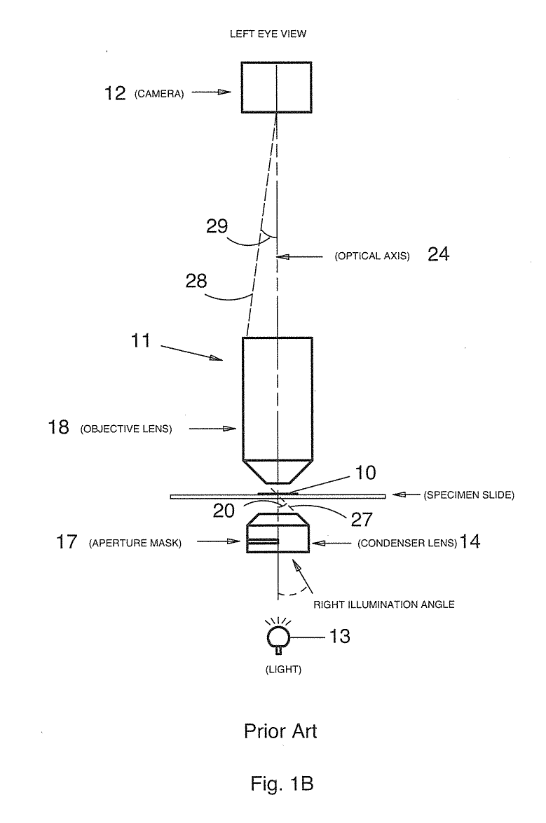

FIGS. 1A and 1B illustrate prior art apparatus using oblique illumination from left and right points of view to produce left-eye and right-eye images that will appear to the viewer as a stereo 3-D image.

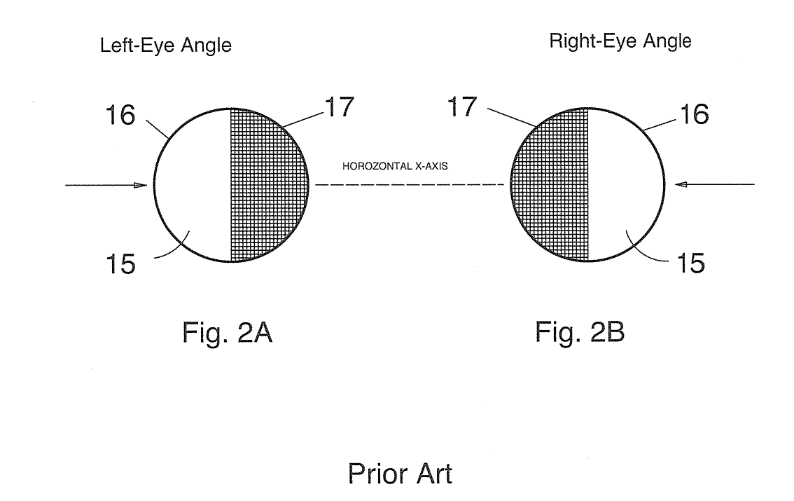

FIGS. 2A and 2B are top views of illumination aperture masks (stops) employed to produce a left-eye view and right-eye view of images in a microscope.

Referring to FIGS. 1A and 2A, according to the prior art, stereo pair images of a specimen 10 can be created in a light microscope 11 and captured in a camera 12. Microscope 11 comprises an illumination source 13, a condenser lens 14 having an aperture 16, an aperture mask 17 that occludes a portion of the aperture 16 and an objective lens 18.

A left eye view image of specimen 10 is created by positioning aperture stop 17 to occlude a portion of the aperture 16 causing the specimen 10 to be illuminated by a light beam 22 that passes through the unoccluded portion 15 of the condenser lens aperture 16 and emerges at an angle 23 relative to the optical axis 24 of the microscope 11. Beam 22 passes through objective lens 18 and emerges as beam 25 at an angle 26 relative to optical axis 24 on its way to the camera 12.

Referring to FIGS. 1B and 2B, according to the prior art, a right eye view of specimen 10 is created by positioning aperture stop 17 to occlude an opposite portion of the aperture 16 causing the specimen 10 to be illuminated by a light beam 27 that passes through the unoccluded portion 15 of the condenser lens 14 and emerges at an angle 28 relative to the optical axis 24 of the microscope 11. Beam 27 passes through objective lens 18 and emerges as beam 28 at an angle 29 relative to optical axis 24 on its way to the camera 12.

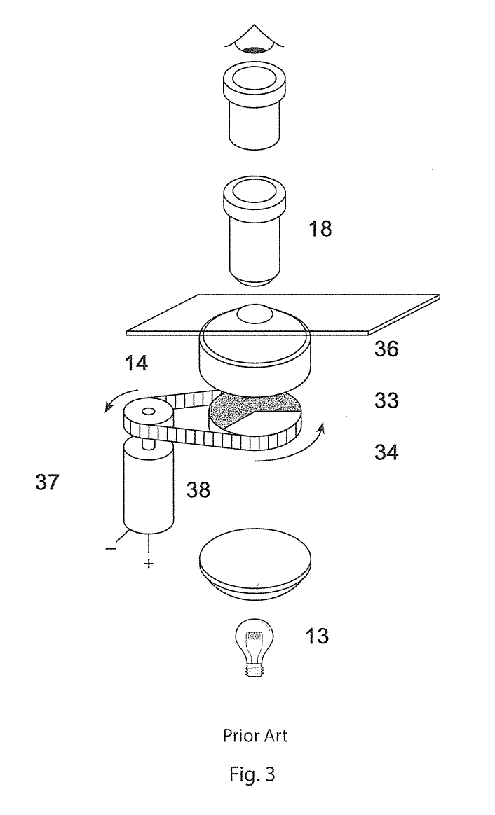

Referring to FIG. 3, it is known in the prior art that an aperture mask 33, such as mask (stop) 17 referred to above, having a light transmitting portion 34 and a light occluding portion 36 can be operatively attached to a motor 37 such as by a belt 38 or the like by which the orientation of the mask 33 can be selected and/or the mask can be rotated to produce illumination from various angles.

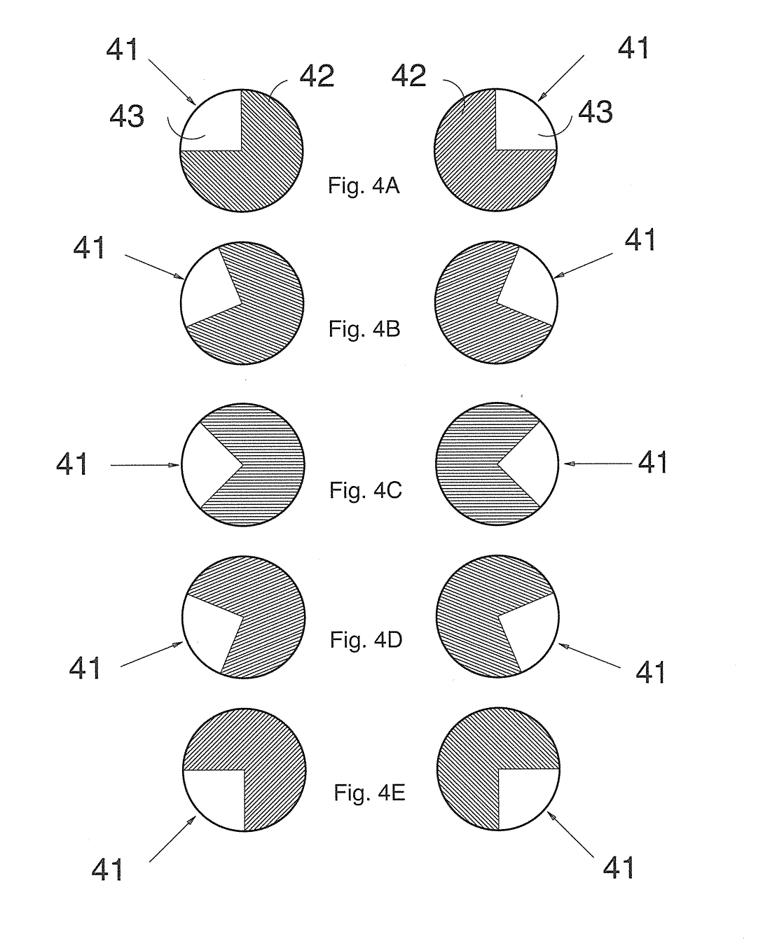

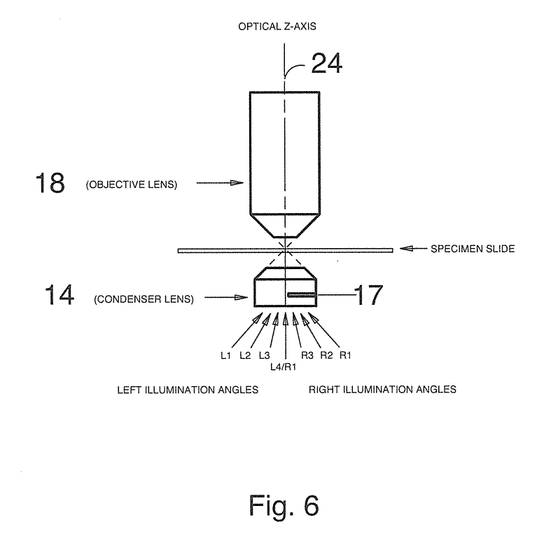

Referring to FIG. 4A, a rotatable microscope aperture mask 41 comprises, an opaque section 42 that occludes light (or emits no light) and a light transmitting or emitting section 43 that emits light. FIG. 4A shows the aperture mask 41 at two corresponding equal but opposite angular positions (mirror images of each other) . FIGS. 4B-4E illustrate the mask 41 at various different equal but opposite angular positions (mirror images of each other). At each angular position a specimen illumination beam 22 that emits from the mask 17 (see FIGS. 1A and 2A) creates a different pair of left-eye view and a right-eye view of the specimen 10. A specimen illumination beam 22 is created at a plurality of successive angles which. when employed in a microscope 11 such as that illustrated in FIG. 1A (see also FIG. 6). produces images that can be captured by a camera 12 and create a video which when viewed has the perception of motion 3-D, in which the specimen appears to rotate.

FIGS. 4A through 4E illustrate examples of progressive angular positions of illumination aperture mask 41 positioned to produce a successive series of stereo-pair images where the angles of view progress from downward tilting angles to upward tilting angles. The left image of FIG. 4A shows the top view of aperture mask 41 positioned to produce an image in the camera that appears to tilt downward and to the right, as shown by the accompanying arrow. The right image of FIG. 4A shows the top view of illumination aperture mask 41 positioned to produce an image in the camera that appears to tilt downward and to the left, as shown by the accompanying arrow. When these two images are seen simultaneously or in quick succession as a stereo-pair, the human brain perceives a stereo 3-D image that appears to tilt straight downward.

The illumination aperture mask 41 at the positions shown in FIG. 4B produces stereo pair 3-D images that appears to tilt downward, but to a lesser degree than the tilt produced by the angular position of the illumination aperture mask 41 shown in FIG. 4A. The angular positions of the illumination aperture mask shown in FIG. 4C produce a conventional stereo 3-D image that does not tilt upward or downward. The angular positions of the illumination aperture mask 41 shown in FIGS. 4D and 4E produce stereo 3-D images that appear to tilt upward to different degrees as illustrated by their accompanying arrows. By creating a sequence of successive 3-D stereo-pair images that progress from the angular positions that progress from 4A to 4B to 4C to 4D to 4E and then from 4E to 4D to 4C to 4B to 4A, and so on, the viewer will perceive a 3-D stereo image of the specimen that appears to rock upward and downward, revealing hidden information not seen from a single conventional stereo pair image.

To produce a “4-D” video (stereo 3-D with motion 3-D tilting), the pattern of lighting elements, the camera exposure, and the display system must be synchronized by a computer algorithm in a precise sequence. FIG. 4 illustrates an example of an embodiment in which successive aperture illumination positions produce a 3-D video loop that tilts up and down as described above.

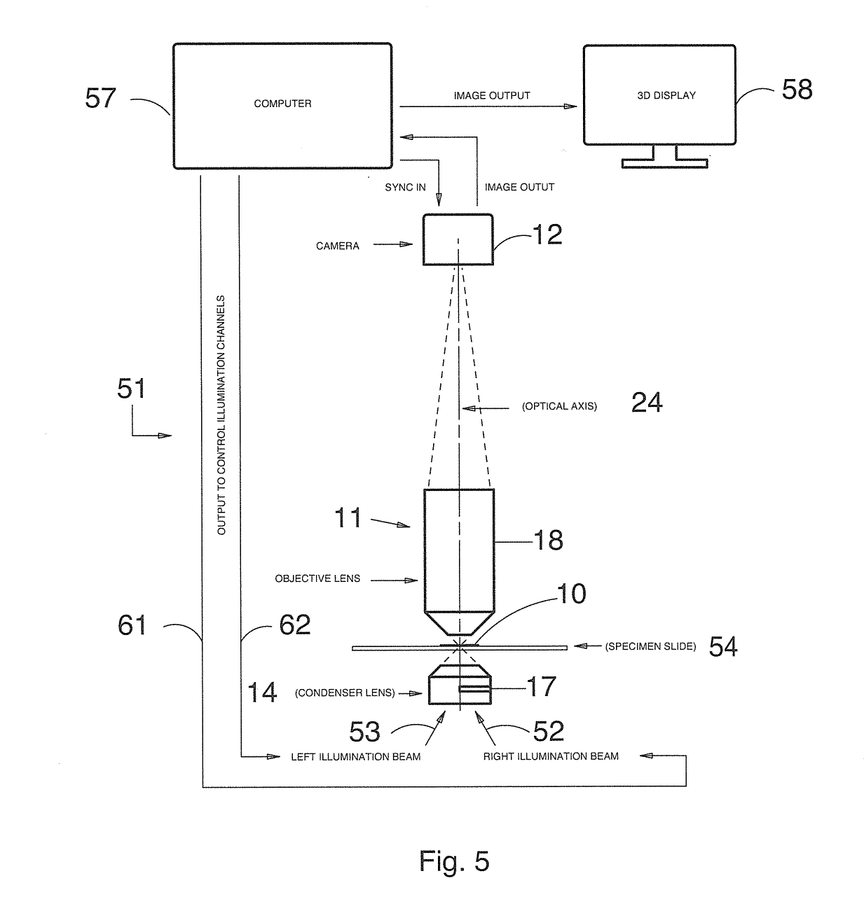

Referring to FIGS. 1A and 5, an example of an embodiment of apparatus 51 to create a “4-D” video of a specimen 10 comprises: a microscope 11 having a condenser lens 14 having an aperture 16, an aperture mask 17 positional to various angles, and an objective lens 18 having an optical axis 24, and a specimen slide 54 supporting a specimen 10; a camera 12 disposed to capture images of the specimen 10; a computer 57 and a 3D monitor (display) 58.

A right eye illumination beam exemplified by arrow 52 is created by positioning mask 17 as previously described, and a left-eye illumination beam exemplified by arrow 53 is created by positioning mask 17 as previously described above (see FIG. 4). The position of the mask 17 and thus the angle of illumination is controlled by computer 57 by way of channels 61 and 62 as, for example, through control of a motor 37 (see FIG. 3).

Assuming the left eye image is captured by camera 12 and displayed on monitor 58 and then the right eye image is captured and displayed in quick succession, in one example of an embodiment of the invention apparatus 51 operates as follows:

In quick succession capture in camera 12 and display on monitor 58 images of the specimen 10 with the aperture mask 17 set as follows:
a. Set oblique illumination masks 41L and 41R to the positions of FIG. 4A and capture the images successively in camera 12 and display on monitor 58; set oblique illumination masks 41L and 41R to the positions of FIG. 4B and capture the images successively in camera 12 and display on monitor 58;
b. Repeat the procedure by successively setting illumination masks 41L and 41R to the positions of FIG. 4C-4E and then continue in the same manner back in the other direction: from positions 4E-4A;
c. Loop the above procedure over and over again.

FIG. 6 illustrates a side view of microscope illumination components condenser lens 14 and objective lens 18 having an optical axis 24 employed to produce non-conventional stereo-pair images using left and right illumination angles that are not symmetrical about the optical axis. FIG. 6 illustrates that image produced in a microscope by a zero angle (relative to the optical axis of the microscope) illumination beam can be used as a right-eye image (R1). By pairing the R1 image with a left-eye image produced by an illumination beam of sufficient parallax difference (i.e., L1), a 3-D stereo image of the specimen will appear to be tilted to the right. FIG. 6 also illustrates that the image formed by an illumination beam normal to the optical axis can also be used as a left-eye image (L4) if the right-eye image (R4) is created by an illumination beam that has a sufficient parallax difference. FIG. 6 illustrates that by pairing images produced by various angled illumination beams a sequence of angled illumination beams can produce a series of unique stereo-pair 3-D images that appear to make the object roll to the right. The reverse sequence of stereo-pair 3-D images appears to make the object roll to the left. These two series of non-conventional stereo-pair images can be repeated to produce a stereo 3-D image that appears to roll from left to right and back to left again, and so forth.

1) Rear Real-time 4-D methods and devices (video rate): The devices consist of an apparatus that can rapidly change the shape and placement of an oblique illumination beam. This is achieved in two basic ways: 1) either by employing a series of multiple lighting elements that are turned on and off in a precise sequence, such as the use of a LCD or DLP illuminator that uses computer-controlled micro-mirrors to illuminate very precise portions of the optical aperture, or 2) by employing specially-shaped opaque aperture stops that obscure portions of the optical aperture for the purpose of creating oblique light beams that move in a precise sequence to produce the desired series of oblique illuminating beams (as illustrated in FIGS. 4, 5 and 6).

2) Reconstructing sequential non-conventional stereo views from a three-dimensional data set: It is known in the art that a three-dimensional data set of images can be produced by sequentially capturing a series of images taken at different focus levels, known in the art as “z-stacking”. The out-of-focus portions of each focus level are usually removed using computer algorithms, leaving just the in-focus information at each level of the data set. Such a three-dimensional data set consists of volumetric pixels (voxels rather than pixels).

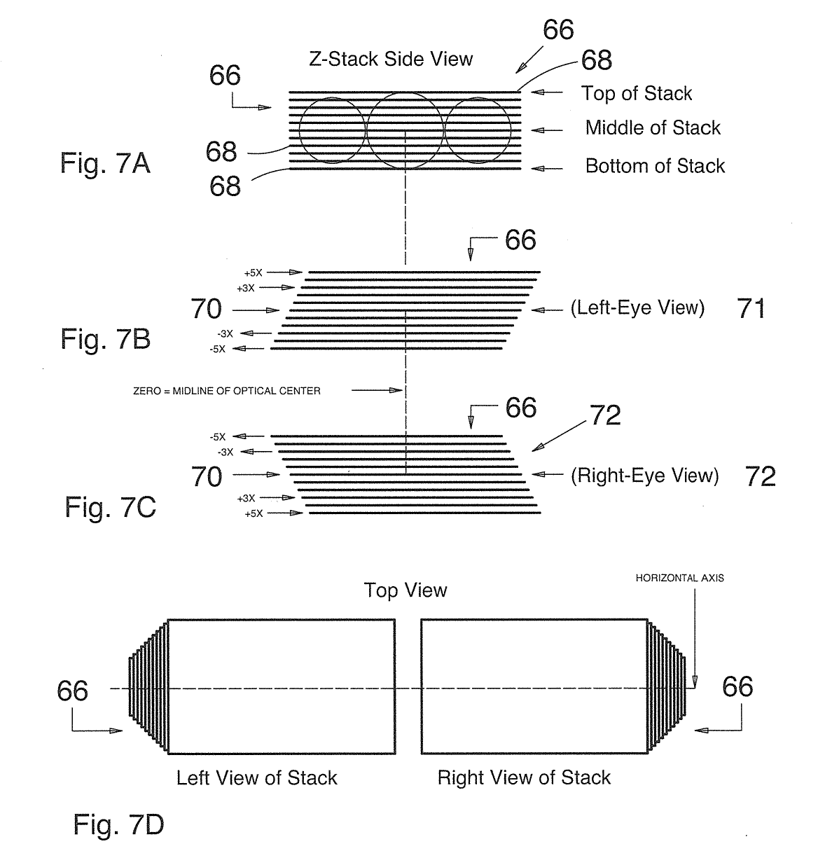

FIG. 7A is a diagram of a side view of a “Z-Stack” 66 of images 67 taken at different focus levels (layers) 68. The microscope specimen is shown as 3 spheres 69. A depth map of the stack of images contains in-focus information about each layer of the specimen (usually between 10 and 30 layers). Each layer can be independently moved or displaced in the X plane relative to the center of the optical axis 70 to produce stereo-pair images (a left eye view 71 and a right eye view 72).

FIG. 7B is a top view of the Z-Stack 66 illustrating how to displace the layers of the Z-stack in the x-axis plane to produce a left-eye view and a right-eye view from the data stack. To produce the left-eye image, each layer in the foreground above the middle layer is successively displaced in the x-plus direction (to the right) by one additional unit for each layer. The displacement is measured by the number of pixels selected to represent one unit of displacement. More pixels per unit will result in larger parallax angles and a greater 3-D effect. To produce the right-eye image, each layer in the foreground above the middle layer is successively displaced in the x-plus direction (to the left) by one additional unit for each layer. The displacement is measured by the number of pixels selected to represent one unit of displacement. More pixels per unit will result in larger parallax angles and a greater 3-D effect.

If, by example, there are 11 layers, as shown n FIG. 7A, then there are 5 top layers and 5 bottom layers. For the left-eye view, the top layers are successively displaced in the x-positive direction and the bottom layers are successively displaced in the x-minus direction. The opposite is true for the right-eye image. FIG. 7B (top view) shows that each image of a conventional stereo-pair is aligned to the horizontal axis.

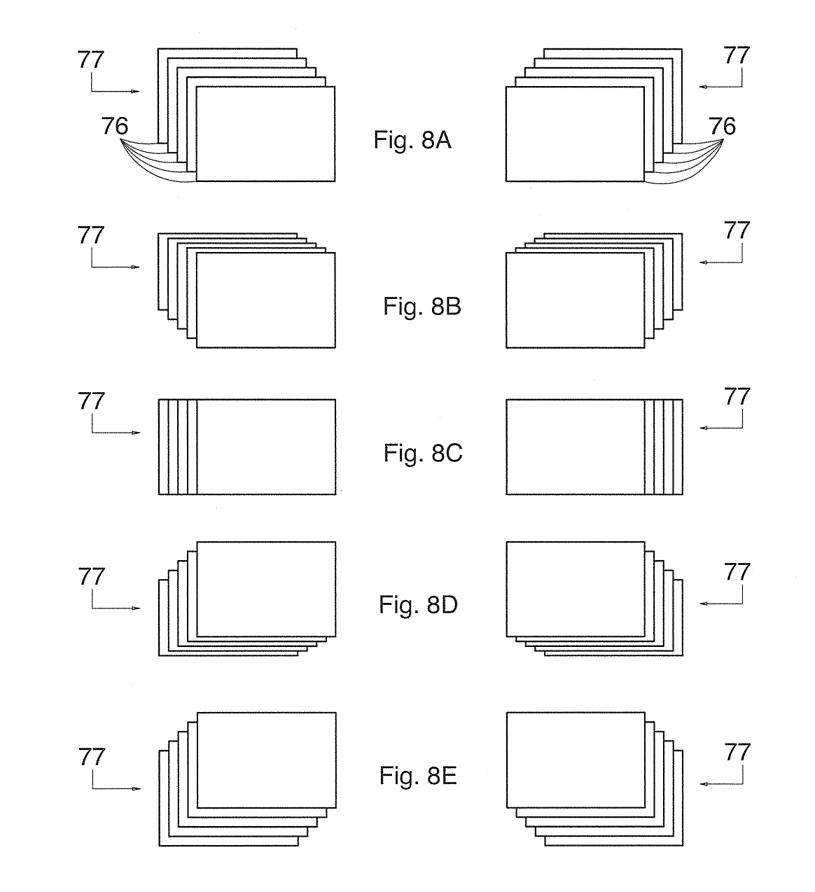

FIGS. 8A through 8E illustrate that by independently displacing each layer 76 of a Z-stack series 77 in both the x-plane as well as the y-plane, a unique series of non-conventional stereo-pair images are created that can be displayed as a 4-D movie loop. FIGS. 8A-8E illustrate the relative displacement of each layer 76 in the sequence of stereo-pair images 77 in Z-stack 76 in order to produce a stereo 4-D movie that appears to tilt upward. If the sequence is reversed, then it will produce a stereo 4-D movie that appears to tilt downward. By repeating the sequences of stereo-pair images as shown from FIG. 8A to FIG. 8E and back to FIG. 8A, the object will appear to rock up and down in stereo 3-D.

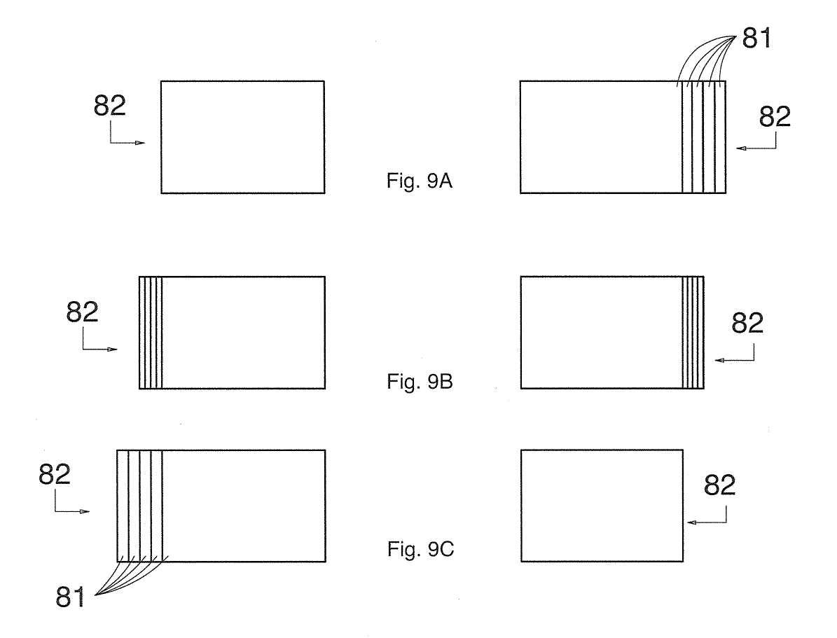

FIG. 9A through 9C illustrate how to displace the layers of images 81 of a Z-stack 82 to achieve a 4-D stereo series that rolls from right to left. By using the same methods disclosed above, a Z-stack 82 of images 81 from a microscope can be reconstructed into a series of images whose layers have been independently displaced in the x-y plane to produce 4-D stereo images that appear to rock, roll, or rotate. The advantage of using the Z-stack data set is a significant increase in the depth of focus compared to the real-time methods discussed above.

What is claimed is:

1. A method of creating a 3-D video of an object using a light microscope having an optical axis comprising:
capturing in a camera a sequence of non-conventional stereo-pair images of the object wherein the images of each stereo-pair are viewed along two different lines of sight; and
delivering the sequence of non-conventional stereo-pair images of the object to a 3-D video display device.

2. The method of claim 1 wherein the non-conventional stereo-pair images of the object include a left-eye view and a right-eye view hose parallax angles are not symmetrical about the optical axis.

3. The method of claim 2 wherein the non-conventional stereo-pair images of the object further include a left-eye view and a right-eye view whose parallax angles are not separated by 180 degrees.

4. The method of claim 3 wherein the non-conventional stereo-pair images of the object further include a left-eye view and a right-eye view whose parallax angles are not aligned with the X-axis plane of the object.
